(19) United States
(12) Patent Application Publication
(10) Pub. No.: US 2025/0079473 A1
(43) Pub. Date: Mar. 6, 2025

(54) OXYGEN REDUCTION REACTION CATALYST AND METHODS OF SYNTHESIZING THE SAME

(71) Applicant: Form Energy, Inc., Somerville, MA (US)

(72) Inventors: Mauricio PAZ, Melrose, MA (US); Danielle Marie BUTTS, Cambridge, MA (US); Liang Su, Medfield, MA (US); Vlad TARASOV, Medford, MA (US); Glenn DONAHEY, Somerville, MA (US)

(73) Assignee: Form Energy, Inc., Somerville, MA (US)

(21) Appl. No.: 18/821,451

(22) Filed: Aug. 30, 2024

Related U.S. Application Data
(60) Provisional application No. 63/580,589, filed on Sep. 5, 2023.
(60) Provisional application No. 63/580,611, filed on Sep. 5, 2023.
(60) Provisional application No. 63/580,617, filed on Sep. 5, 2023.

(51) Int. Cl. H01M 4/90; C01G 45/12; C01G 49/00; C01G 53/00; H01M 4/88; H01M 12/00

(52) U.S. Cl. CPC H01M 4/9016; C01G 45/1264; C01G 49/0072; C01G 53/70; H01M 4/8807; H01M 4/9083; H01M 12/00; C01P 2002/34; C01P 2002/72; C01P 2006/12; C01P 2006/40

(57) ABSTRACT

A composition includes a compound of the formula AₓM_{y}O_{z}, wherein A is an A-site element and includes Ba, Ca, Cu, Dy, Er, Gd, La, Nd, Pr, Sm, Sr, Y, or Yb, or a combination thereof, M is an M-site element and includes Co, Cu, Fe, Mn, Ni, Ti, Sc, or P, or a combination thereof, and 0<x≤1, 0<y≤2, (3−δ)≤z≤(4−δ), and 1<δ<1. Use of the composition as a catalyst composition, for example an oxygen reduction reaction catalyst composition, in gas diffusion electrodes, and in metal-air batteries is also described.

### CROSS REFERENCE TO RELATED APPLICATIONS

This application claims priority to and the benefit of U.S. Provisional Application No. 63/580,589, filed Sep. 5, 2023, U.S. Provisional Application No. 63/580,611, filed Sep. 5, 2023, and U.S. Provisional Application No. 63/580,617, filed Sep. 5, 2023, the contents of each of which are hereby incorporated by reference in their entirety.

### BACKGROUND

Energy storage technologies are playing an increasingly important role in electric power grids. At a most basic level, energy storage devices provide power smoothing to better match generation and demand on a grid. The services performed by energy storage devices are beneficial to electric power grids across multiple time scales, from milliseconds to years. Today, energy storage technologies exist that can support timescales from milliseconds to hours. Still, there remains a need for long and ultra-long duration energy storage systems having a duration of at least 8 hours.

Metal air batteries are a promising technology for long duration energy storage systems (LODES), due to the abundance and rechargeability of metal anodes and the abundance, high energy density, and low cost of air as a reagent. Specifically, for the positive air electrode, a gas diffusion electrode (GDE) is the most popular choice. On one side of the GDE, oxygen or air as a reactant is taken up by the GDE through a gas diffusion layer and transported to a reaction layer; on the other side of the GDE, an electrolyte contacts the reaction layer containing active components such as catalyst and carbon where an oxygen reduction reaction occurs.

There remains a need for an improved air electrode catalyst, and methods of making the same. It would be particularly advantageous for such a catalyst to have high intrinsic activity towards oxygen reduction, high surface area, high crystallinity, cost effectiveness, and tunable stoichiometry for high throughput optimization.

### SUMMARY

An aspect of the present disclosure is a composition comprising a compound of the formula AₓM_{y}O_{z}, wherein A comprises Ba, Ca, Cu, Dy, Er, Gd, La, Nd, Pr, Sm, Sr, Y, or Yb, or a combination thereof, M comprises Co, Cu, Fe, Mn, Ni, Ti, Sc, or P, or a combination thereof, and 0<x≤1, 0<y≤2, (3−δ)≤z≤(4−δ), and 0≤δ≤1.

Another aspect is an oxygen reduction reaction catalyst comprising the composition.

Another aspect is a gas diffusion electrode comprising an oxygen reduction reaction catalyst comprising the composition.

Another aspect is a metal-air battery comprising: a negative electrode comprising a metal; a positive electrode comprising a gas diffusion electrode; and an electrolyte contacting at least one of the negative electrode or the positive electrode, wherein the positive electrode comprises the composition.

A method of preparing the composition comprises: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel-formation solution; contacting the gel-formation solution and the first solution to form a second solution; heating the second solution to evaporate the water and provide a gel; and heat-treating the gel to prepare the compound.

Another aspect is a method of preparing the composition, the method comprising: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel-formation solution; contacting the gel-formation solution and the first solution to form a second solution; heating the second solution to evaporate the water and provide a gel; heat-treating the gel to prepare the compound; and post-treating the compound to provide the composition.

A method of preparing a gas diffusion electrode comprises providing an electrode; providing the catalyst comprising the composition; and disposing the catalyst on the electrode to prepare the gas diffusion electrode.

A method of preparing a metal-air battery comprises providing a negative electrode comprising a metal; providing a positive electrode comprising the gas diffusion electrode; and contacting the negative electrode and the positive electrode with an electrolyte to prepare the metal-air battery.

A method of operating a metal-air battery comprises providing the metal-air battery; providing a load between the positive electrode and the negative electrode; and discharging the battery to provide power to the load for at least a total of 1000 hours to operate the metal-air battery at a cell temperature between 1° and 80° C. in an alkaline electrolyte with pH>14.

The above described and other features are exemplified by the following detailed description.

### DETAILED DESCRIPTION

The specific surface area (SSA, often with units of square meters per gram (m²/g)) of an oxygen reduction reaction (ORR) catalyst is a strong lever for improving the gas diffusion electrode (GDE) performance. For example, a factor of 10 increase of the SSA may lead to up to a factor of 10 increase in the intrinsic ORR catalyst activity (A/g), which in turn may lead to increased GDE performance, e.g., up to 50 millivolts (mV) at 12 milliamps per square centimeter (mA/cm²). For an ORR catalyst having a SSA of less than 12 square meters per gram (m²/g), improved GDE performance may be provided by increasing the SSA of the ORR catalyst species. Greater SSA may also lead to a net decrease in the ORR catalyst cost because less material may provide the same activity, providing reduced cost without compromising the GDE performance. Nonetheless, improving catalyst SSA remains a complex and difficult challenge.

To provide an ORR catalyst having a greater specific surface area, disclosed is a metal oxide composition having improved particle size distribution, and methods of producing the same. The metal oxide can be used as a catalyst for oxygen reduction, oxygen evolution, peroxide reduction, peroxide oxidation, or chemical decomposition of peroxide.

Accordingly, an aspect of the present disclosure is a composition. The composition comprises a compound comprising a metal oxide. In certain aspects, the compound is a metal oxide of the formula AₓM_{y}O_{z}, wherein A is an A site element and comprises Ba, Ca, Cu, Dy, Er, Gd, La, Nd, Pr, Sm, Sr, Y, or Yb, or a combination thereof, M is an M site element and comprises Co, Cu, Fe, Mn, Ni, Ti, Sc, P, or a combination thereof, and 0≤x≤1, 0<y≤2, (3−δ)≤z≤(4−δ), and 0<δ<1. In certain aspects, x:y>1. In certain aspects, x:y<1. In certain aspects, x:y=1. In certain aspects, z≥3. In certain aspects, z≤3. In certain aspects, z≤4. In an aspect, A comprises Ba, Ca, Cu, Dy, Er, Gd, La, Nd, Pr, Sm, Sr, Y, or Yb, or a combination thereof. In an aspect, M comprises Co, Cu, Fe, Mn, Ni, Ti, Sc, P, or a combination thereof. In an aspect z is (3−δ), and 0≤δ<1, or 0≤δ<0.5. In an aspect, x>y, x<y, or x=y.

In an aspect, A is A1 and A2, M is M1 and M2, and the compound has a nominal formula of [A1ₓ₁A2ₓ₂]ₐ[M1_{y1}B2_{y2}]_{b}O_{3-δ}, wherein x1+x2=1, 0<x1≤1, 0≤x2≤1, 0<a≤1, y1+y2=1, 0<y1≤1, 0≤y2≤1, 0<b≤1, 0≤δ≤0.5. In an aspect, A1 and A2 are each independently Ba, Ca, Cu, Dy, Er, Gd, La, Nd, Pr, Sm, Sr, Y, or Yb, and M1 and M2 are each independently Co, Cu, Fe, Mn, Ni, Ti, Sc, or P. Preferably, when A is A1 and A2, A1 and A2 are not the same. Preferably, when M is M1 and M2, M1 and M2 are not the same. In an aspect, A1 is a lanthanum group element, A2 is a Group 2 element, and M is a Group 7 element, wherein the lanthanum group element (e.g., lanthanides) refers to an element in the Periodic Table of the Elements having atomic numbers 57 to 71, and “Group” means a group of the Periodic Table of the Elements according to the International Union of Pure and Applied Chemistry (“IUPAC”) Group 1-18 group classification system.

In an aspect, A1 is La, A2 is Sr, M1 is Mn, y2=0, and b=1. In an aspect, the compound is of a nominal formula [Laₓ₁Srₓ₂]ₐMnO_{3-δ}, wherein 0.1≤x1≤0.9, 0.1≤x2≤0.9, a=1, and 0≤δ≤0.5. In an aspect, the composition can comprise a compound comprising La_{0.1}Sr_{0.9}MnO_{3-δ}, La_{0.15}Sr_{0.85}MnO_{3-δ}, La_{0.2}Sr_{0.8}MnO_{3-δ}, La_{0.25}Sr_{0.75}MnO_{3-δ}, La_{0.3}Sr_{0.7}MnO_{3-δ}, La_{0.35}Sr_{0.65}MnO_{3-δ}, La_{0.4}Sr_{0.6}MnO_{3-δ}, La_{0.45}Sr_{0.85}MnO_{3-δ}, La_{0.5}Sr_{0.5}MnO_{3-δ}, La_{0.55}Sr_{0.45}MnO_{3-δ}, La_{0.6}Sr_{0.4}MnO_{3-δ}, La_{0.65}Sr_{0.45}MnO_{3-δ}, La_{0.7}Sr_{0.3}MnO_{3-δ}, La_{0.75}Sr_{0.25}MnO_{3-δ}, La_{0.8}Sr_{0.2}MnO_{3-δ}, La_{0.85}Sr_{0.15}MnO_{3-δ}, or La_{0.9}Sr_{0.1}MnO_{3-δ}, wherein δ is each independently 0≤δ≤0.5.

In an aspect, A1 is La, A2 is Sr, M1 is Mn, y2=0, and b=1. In an aspect, the compound is of a nominal formula [Laₓ₁Srₓ₂]ₐMnO_{3-δ}, wherein 0.1≤x1≤0.9, 0.1≤x2≤0.9, a=0.95, and 0≤δ≤0.5. In an aspect, the composition can comprise a compound comprising [La_{0.1}Sr_{0.9}]_{0.95}MnO_{3-δ}, [La_{0.15}Sr_{0.85}]_{0.95}MnO_{3-δ}, [La_{0.2}Sr_{0.8}]_{0.95}MnO_{3-δ}, [La_{0.25}Sr_{0.75}]_{0.95}MnO_{3-δ}, [La_{0.3}Sr_{0.7}]_{0.95}MnO_{3-δ}, [La_{0.35}Sr_{0.65}]_{0.95}MnO_{3-δ}, [La_{0.4}Sr_{0.6}]_{0.95}MnO_{3-δ}, [La_{0.45}Sr_{0.85}]_{0.95}MnO_{3-δ}, [La_{0.5}Sr_{0.5}]_{0.95}MnO_{3-δ}, [La_{0.85}Sr_{0.45}]_{0.95}MnO_{3-δ}, [La_{0.6}Sr_{0.4}]_{0.95}MnO_{3-δ}, [La_{0.65}Sr_{0.35}]_{0.95}MnO_{3-δ}, [La_{0.7}Sr_{0.3}]_{0.95}MnO_{3-δ}, [La_{0.7}5Sr_{0.25}]_{0.95}MnO_{3-δ}, [La_{0.8}Sr_{0.2}]_{0.95}MnO_{3-δ}, [La_{0.85}Sr_{0.15}]_{0.95}MnO_{3-δ}, [La_{0.9}Sr_{0.1}]_{0.95}MnO_{3-δ}, wherein δ is independently at each occurrence 0≤δ≤0.5.

In an aspect, A1 is La, A2 is Sr, M1 is Mn, y2=0, and b=1. In an aspect, the compound is of a nominal formula [Laₓ₁Srₓ₂]ₐMnO_{3-δ}, wherein 0.1≤x1≤0.9, 0.1≤x2≤0.9, a=0.9, and 0≤δ≤0.5. In an aspect, the composition can comprise a comprise a compound comprising [La_{0.1}Sr_{0.9}]_{0.9}MnO_{3-δ}, [La_{0.15}Sr_{0.85}]_{0.9}MnO_{3-δ}, [La_{0.2}Sr_{0.8}]_{0.9}MnO_{3-δ}, [La_{0.25}Sr_{0.75}]_{0.9}MnO_{3-δ}, [La_{0.3}Sr_{0.7}]_{0.9}MnO_{3-δ}, [La_{0.35}Sr_{0.65}]_{0.9}MnO_{3-δ}, [La_{0.4}Sr_{0.6}]_{0.9}MnO_{3-δ}, [La_{0.45}Sr_{0.85}]_{0.9}MnO_{3-δ}, [La_{0.5}Sr_{0.5}]_{0.9}MnO_{3-δ}, [La_{0.85}Sr_{0.45}]_{0.9}MnO_{3-δ}, [La_{0.6}Sr_{0.4}]_{0.9}MnO_{3-δ}, [La_{0.65}Sr_{0.35}]_{0.9}MnO_{3-δ}, [La_{0.7}Sr_{0.3}]_{0.9}MnO_{3-δ}, [La_{0.75}Sr_{0.25}]_{0.9}MnO_{3-δ}, [La_{0.8}Sr_{0.2}]_{0.9}MnO_{3-δ}, [La_{0.85}Sr_{0.15}]_{0.9}MnO_{3-δ}, [La_{0.9}Sr_{0.1}]_{0.9}MnO_{3-δ}, wherein δ is independently at each occurrence 0≤δ≤0.5.

In an aspect, A1 is La, A2 is Sr, M1 is Mn, and M2 is Fe. In an aspect, the compound is of a nominal formula [Laₓ₁Srₓ₂]ₐ[Mn_{y1}Fe_{y2}]_{b}O_{3-δ}, wherein x1+x2=1, 0.1≤x1≤0.9, 0.1≤x2≤0.9, 0.9≤a≤1, y1+y2=1, 0.1≤y1≤0.9, 0.1≤y2≤0.9, b=1, and 0≤δ≤0.5.

In an aspect, A1 is La, A2 is Sr, M1 is Mn, and M2 is Co. In an aspect, the compound is of a nominal formula [Laₓ₁Srₓ₂]ₐ[Mn_{y1}Co_{y2}]_{b}O_{3-δ}, wherein x1+x2=1, 0.1≤x1≤0.9, 0.1≤x2≤0.9, 0.9≤a≤1, y1+y2=1, 0.1≤y1≤0.9, 0.1≤y2≤0.9, b=1, and 0≤δ≤0.5.

In an aspect, A1 is La, A2 is Sr, M1 is Mn, and M2 is Ni. In an aspect, the compound is of a nominal formula [Laₓ₁Srₓ₂]ₐ[Mn_{y1}Ni_{y2}]_{b}O_{3-δ}, wherein x1+x2=1, 0.1≤x1≤0.9, 0.1≤x2≤0.9, 0.9≤a≤1, y1+y2=1, 0.1≤y1≤0.9, 0.1≤y2≤0.9, b=1, and 0≤δ≤0.5.

The metal oxide may have any suitable structure. Use of a metal oxide having a perovskite structure is disclosed. The perovskite may be a layered perovskite. Perovskite has a formula often referred to as ABO₃, however for clarity and to avoid confusion with boron, referred to herein as AMO₃. Perovskite has a crystal structure that is isostructural with perovskite, i.e., CaTiO₃. A layered perovskite is a type of perovskite structure where additional layers of atoms or ions are inserted between the typical perovskite layers. Layered perovskites can be represented using the formula Aₙ₊₁MₙO₃ₙ₊₁, wherein n is a natural number. For n=1, the molecular formula is A₂MO₄=(AMO₃)AO. The structure of the layered perovskite where n=1 has a set of two layers of AO followed by one layer of MO₂. For n=2, the molecular formula is A₃M₂O₇=(AMO₃)₂AO. The structure of the layered perovskite where n=2 has a set of three layers of AO followed by two layers of MO₂. For n=3, the molecular formula is A₄M₃O₁₀=(AMO₃)₃AO. The structure of the layered perovskite where n=3 has a set of four layers of AO followed by three layers of MO₂. For n=∞, the molecular formula is AMO₃, which has single AO and MO₂ layers alternatively stacked.

In a specific aspect, the composition can have a perovskite structure, and can have peaks centered at 2θ values of 31.6° to 33.9°, 39.4° to 41.6°, and 46.2° to 48.2°, when analyzed by X-ray diffraction using CuKα radiation, preferably wherein the peaks have a full-width-at-half-maximum of 0.3° to 1.3°.

In an aspect, the composition comprises the metal oxide compound and has a specific surface area (SSA) greater than 0.1, 1, 10, 50, or 100 m²/g. In an aspect, the SSA may be 0.1 to 500 m²/g, 1 to 300 m²/g, 0.1 to 100 m²/g, 10 to 200 m²/g, 30 to 150 m²/g, or 50 to 100 m²/g. The SSA may be determined by the Brunauer-Emmett-Teller (BET) method. The BET method is described in Brunauer, Stephen; Emmett, P. H.; Teller, Edward (1938), “Adsorption of Gases in Multimolecular Layers,” Journal of the American Chemical Society. 60 (2): 309-319, the content of which is incorporated herein by reference in its entirety. The BET method used to determine particle size can be as set forth in ISO 9277 or in ASTM D3663.

In an aspect, the composition has an average particle size of 20 to 4000 nanometers (nm), 40 to 2000 nm, or 80 to 1000 nm, and a preferred particle size range of 100 to 800 nm, 200 to 600 nm, or 300 to 400 nm. The average particle size may be determined by measuring the average of a particle diameter, wherein the particle diameter of each particle may be determined by measuring the longest axis of each particle. The average size may be determined by analyzing the sizes of the particles by scanning electron microscopy or by dynamic light scattering.

Methods for the manufacture of the compound are also described herein. In some aspects, the compounds are synthesized by a solution-based synthesis process, including but not limited to a sol-gel process, a reverse homogeneous precipitation process, or a reverse micelle process.

In an aspect, a method of preparing a compound comprises: providing a metal salt; providing a gel formation solution; contacting the metal salt with the gel formation solution to provide a metal compound network; heating the metal compound network to provide a calcined product; and post-treating the calcined product to prepare the composition.

The metal salt comprises a cation and an anion. The cation may be a cation of an A site element, an M site element, or a combination thereof. The cation may be a cation of Ba, Ca, Cu, Dy, Er, Gd, La, Nd, Pr, Sm, Sr, Y, or Yb, or a combination thereof, or Co, Cu, Fe, Mn, Ni, Ti, Sc, P, or a combination thereof. Any suitable anion may be used. The anion may be sulfate, formate, acetate, hexafluorophosphate, chloride, tetrafluoroborate, citrate, nitrate, triflate, bicarbonate, or a combination thereof.

The metal salt may be provided in a form of a solution of the metal salt, such as an aqueous solution of the metal salt. In some aspects, the metal salt solution is provided in a form of a nonaqueous solution comprising a nonaqueous solvent. The nonaqueous solvents may include acetone, ethanol, diethyl ether, dimethyl sulfoxide, toluene, hexane, xylene, chloroform, acetonitrile, methanol, ethyl acetate, or a combination thereof. In certain aspects, the nonaqueous solution contains a polar solvent, for example, acetone, methanol, ethanol, isopropanol, acetonitrile, dimethyl sulfoxide, dimethylformamide, ethyl acetate, N,N-dimethylacetamide, or a combination thereof. In some aspects, the metal salts solution contains both aqueous and nonaqueous solvents. The metal salt may have a concentration of greater than 0.001 moles per liter (M), greater than 0.01 M, greater than 0.1 M, or greater than 1 M, for example, 0.001 to 5 M, 0.01 to 4 M, 0.1 to 3 M, or 1 to 2 M.

The pH of the metal salt solution may be selected to be at most pH 12, in an aspect, pH 3 to pH 12, pH 4 to pH 11, or pH 4 to pH 10. The pH may be provided by adding a suitable acid, such as nitric acid, or a suitable base, such as sodium hydroxide, to the metal salt solution.

The metal salt solution may comprise a polymer template. Representative polymer templates include, but are not limited to polymethyl methacrylate (PMMA), polytetrafluoroethylene (PTFE), or poly(ethylene-co-butylene)-b-poly(ethylene oxide) diblock copolymer. In some aspects, heat, stirring, or sonication are used to form the metal salt solution.

A precursor material for the A element can be an oxide of the A element and have a selected valence state. A mixture of different oxides with different valence states can be used. A metal of the A site element can be used.

In some aspects, the gel formation solution is an aqueous solution. In some aspects, the gel formation solution is a nonaqueous solution. In certain aspects, the nonaqueous solution contains a polar solvent. In some aspects, the gel formation solution contains both aqueous and nonaqueous solvents. The nonaqueous solvents may include acetone, ethanol, diethyl ether, dimethyl sulfoxide, toluene, hexane, xylene, chloroform, acetonitrile, methanol, ethyl acetate, or a combination thereof. In certain aspects, the nonaqueous solution contains a polar solvent, for example, acetone, methanol, ethanol, isopropanol, acetonitrile, dimethyl sulfoxide, dimethylformamide, ethyl acetate, N,N-dimethylacetamide, or a combination thereof. In some aspects, the gel formation solution contains, but not limited to, a C1 to C5 alkoxide, bromide, carbonate, citrate, chloride, hydroxide, oxide, sulfate, sulfide, or a combination thereof. In some aspects, the gel formation solution contains a hydroxide including, but not limited to, lithium, sodium, potassium, cesium, ammonium, tetramethylammonium, tetraethylammonium, tetrapropylammonium, tetrabutylammonium, or a combination thereof.

In some aspects, the gel formation solution contains one or more stabilizer compounds. In certain aspects, the stabilizer compound is an amine, and can be a primary amine, secondary amine, tertiary amine, or a combination thereof. A concentration of the stabilizer compound may be 0.0001 to 1 mol/L, 0.001 to 0.1 mol/L, or 0.01 to 0.05 mol/L. In a non-limiting example, the amine is triethylamine, triethanolamine, oleylamine, or a combination thereof. In some aspects, the stabilizer compound is a salts comprising is bulky cation, such as, but not limited to, tetramethylammonium, tetraethylammonium, tetrapropylammonium, tetrabutylammonium, cetyltrimethylammonium, or a combination thereof. In some aspects, the stabilizer compound is a salt containing an anion. Representative anions include, but are not limited to, sulfate, nitrate, bromide, chloride, or a combination thereof. The stabilizer may be a complexing agent, such as a hydrated or anhydrous salt of alanine, aspartic acid, citric acid, ethylenediaminetetraacetic acid, glutamic acid, malic acid, lactic acid, tartaric acid, or oxalic acid. A combination comprising at least one of the foregoing stabilizer compounds, specifically at least one of the foregoing complexing agents, may be used. A pure enantiomer of the complexing agent may be used. A racemic mixture of two enantiomers of the same complexing agent may be used. The racemic mixture may be a mixture of equal quantities of two enantiomers. A coordinating and crosslinking polymer, such as alginate, can be used. In certain aspects, the gel formation solution contains propylene oxide. In certain aspects, the gel formation solution contains a polyhydroxy alcohol.

In some aspects, the metal compound network is a gel and comprises one or more A site metal elements including but not limited to Ba, Ca, Cu, Dy, Er, Gd, La, Nd, Pr, Sm, Sr, Y, or Yb, or a combination thereof. In some aspects, the metal compound network (gel) contains one or more M-site metal elements including but not limited to Co, Cu, Fe, Mn, Ni, Ti, Sc, P, or a combination thereof. In some aspects, the metal compound network (gel) contains but is not limited to an alkoxide such as a C1 to C5 alkoxide, carbonate, hydroxide, oxide, sulfate, acetate, chloride, sulfide, oxalate, or a combination thereof. In some aspects, the metal compound network (gel) is formed by adding the metal salts solution (sol) into the gel formation solution with a selected mixing rate of 1 to 1000 milliliters per second per 1000 milliliters of the first solution, 5 to 500 milliliters per second per 1000 milliliters of the first solution, 10 to 100 milliliters per second per 1000 milliliters of the first solution. In an aspect, a volume ratio of metal salt solution to gel formation solution is between 3 to 1 and 1 to 5. In an aspect, a ratio of the A-site element to the M-site element of the metal compound network is less than 1, preferably 0.9 to 1. In an aspect, when there are two A-site elements, a ratio of the two A-site elements can be 4:1 to 1:4, i.e., 4 to 0.25. In an aspect, when there are two M-site elements, the ratio of the two M-site elements is 19:1 to 1:19. In some aspects, the metal compound network (gel) is formed by adding the gel formation solution into the metal salts solution (sol) in the aforementioned selected ratio. In some aspects the mixing process is completed in a batch reactor. In some aspects, the mixing process is completed in a continuous reactor. In some embodiments, the mixing process is completed in a continuous stirred tank reactor (CSTR). In some aspects, the metal compound network (gel) is formed by a filtration process. In some aspects, the metal compound network (gel) is formed through a heating process. The heating process may include heating at a temperature of 30 to 120° C., 80 to 130° C., or 90 to 110° C., at a heating rate of 1 to 5° C./minute (min), 1 to 3° C./min, or 2° C./min, for a duration of 0.5 to 6 hours, 1 to 4 hours, or 2 to 3 hours. In some aspects, an aggregation inhibitor may be added to the metal compound network (gel). Representative aggregation inhibitors include, but are not limited to, ZnO, TiO₂, or SiO₂. A combination of aggregation inhibitors may be used. A concentration of the aggregation inhibitor may be 0.0001 to 10 weight percent (wt %), 0.001 to 1 wt %, or 0.01 to 0.1 wt %, based on a total weight of the gel. In an aspect, the metal compound network may be a colloidal gel formed through sol-gel synthesis methods, the details of which can be determined by one of skill in the art without undue experimentation. The metal compound network can be obtained by contacting a solution comprising the complexing agent with the metal cation-containing solution. Examples of complexing agent solution include aspartic acid and ammonia dissolved in water and ethylene glycol, or EDTA and NaOH dissolved in water. A polymerizable complex gel can be obtained by mixing the metal cation solution, the complexing agent solution, and the precursor(s) for the polymerization reaction. Examples of precursors for the polymerization reaction are ethylene glycol and a carboxylic acid. A gel with coordinating and crosslinking polymers can be made by mixing the metal cation-containing solution, the complexing agent solution, and the precursors for the promotion or catalysis of the crosslinking or polymerization reactions.

In some aspects, the solution is treated using heat or pressure to form the desired precursor material. In some aspects, the metal compound network (gel) is dried by a freeze-drying process prior to calcination. The freeze-drying process involves sublimation of the solvent at low pressures to retain the structure of the as-made material. In some aspects, a solvent exchange method is used prior to drying. The solvent exchange method involves changing the solvent in which the precursor solution is substituted with a miscible, higher or lower vapor pressure solvent to provide suitable drying conditions.

The precursor material (e.g., the gel), may be converted to a metal oxide by pyrolysis in a selected atmosphere. The pyrolysis may comprise combustion of organic materials in the 300 to 500° C. range, for 30 min to 5 hours, preferably between 1 hour and 3 hours. Heating rate may be between 0.5° C./min and 20° C./min, preferably between 0.5° C./min and 5° C./min. The conditions of this combustion reaction are selected to control the nucleation density for the target metal oxide, e.g., to provide a metastable phase for each component of the metal oxide. The properties of the metastable phase may be selected to provide a desired particle morphology, phase purity, degree of homogeneity, or crystallinity of the product metal oxide. In some aspects, a calcination step is included in the solution based process to convert the metal compound network (gel) to the pre-treated materials of interest. In some aspects, the calcination temperature is >300° C., >500° C., or >700° C., in an aspect, 300° C. to 1500° C., 500° C. to 1300° C., or 600° C. to 1000° C. In an aspect, the calcination pressure may be between 3 pounds per square inch gauge (psig) and 0.01 psig, preferably between 1 psig and 0.05 psig. Partial pressure of oxygen may be between 0.11 and 1 psig. In certain aspects, a temperature profile may be used, e.g., within a calcination process. A temperature for the first step of the temperature profile may be between 30° C. and 600° C., preferably between 190° C. and 500° C. A temperature for the second step of the temperature profile may be between 190° C. and 1500° C., preferably between 500° C. and 900° C. The duration for each step may be 30 min to 5 hours, respectively, preferably between 1 hour and 3 hours, respectively. Heating rate for each step may be between 0.5° C./min and 20° C./min, respectively, preferably between 0.5° C./min and 5° C./min, respectively.

In some aspects, the calcination is performed under a carrier gas such as, but not limited to, air, argon, carbon monoxide, forming gas, hydrogen, methane, nitrogen, oxygen, or a combination thereof. In certain aspects, the specification of carrier gas is in accordance with the temperature profile. In certain aspects, the flow rate of carrier gas is in accordance with the temperature profile. For example, moisture-free, CO₂-free synthetic air may be introduced at a flow rate of 10 to 30 cubic centimeters (ccm) per minute (min), 15 to 25 ccm/min, or 20 ccm/min during calcination. In some aspects, the calcination is performed in the presence of another source of carbon serving as the “oxygen getter” or reducing agent. In some aspects, the calcination is performed in a batch reactor. In some aspects, the calcination is performed in a continuous reactor.

In an aspect, post-treatment of the calcined product may be performed.

In some aspects, the calcined product is contacted with water to increase its purity, e.g., to remove a water soluble impurity. In some aspects, the calcined product is contacted with a nonaqueous solvent. In some aspects, the calcined product is contacted with a mixture of water and a nonaqueous solvent. In some aspects, the calcined product is contacted with an aqueous solution. In some aspects, the calcined product is treated by contacting with a plasma. A plasma is an ionized gas of ions, and while not wanting to be bound by theory, during plasma treatment, reactive species in the plasma are understood to interact with the material's surface, which may remove organic contaminants, dust, and oxides from the surface. In some aspects, the calcined product is treated with ozone. In some aspects, the calcined product is milled. The milling can be performed using a ball mill, planetary mill, vortex mill, mixer mill, or a combination thereof. Mentioned is use of a ball mill with yttria stabilized zirconia, zirconia, or tungsten carbide milling media for 0.01 to 100 hours, or 0.1 to 10 hours, at 100 to 2000 RPM, or 200 to 1500 RPM.

The materials obtained from one calcination protocol can be combined with one or more materials made by a similar synthesis method. This combination can be mixed in the dry powder form or as a wet slurry in any suitable form.

In an aspect, the method can further comprise disposing the metal compound network on a support material (i.e., a support). The support may be introduced to the composition after forming the metal compound network, or before contacting the metal salt solution and the gel formation solution. In some aspects, the calcined product is mixed with the supports using a milling process, using but not limited to ball mill, planetary mill, vortex mill, mixer mill, or a combination thereof.

In an aspect, a method of preparing the composition comprises: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel-formation solution; contacting the gel-formation solution and the first solution to form a second solution; heating the second solution to evaporate the water and provide a gel; and heat-treating the gel to prepare the compound.

In an aspect, the A-site precursor is a sulfate, formate, acetate, hexafluorophosphate, chloride, tetrafluoroborate, citrate, nitrate, triflate, bicarbonate, or a combination thereof. In an aspect, the M-site precursor is a sulfate, formate, acetate, hexafluorophosphate, chloride, tetrafluoroborate, citrate, nitrate, triflate, bicarbonate, or a combination thereof.

In an aspect, the providing a gel-formation solution comprises dissolving an organic acid in water, preferably wherein the organic acid is a carboxylic acid, an aspartic acid, an acetic acid, an ethylenediaminetetraacetic acid, a malic acid, or a combination thereof. In an aspect, the method may further comprise adding a base to the gel-formation solution, preferably sodium hydroxide, potassium hydroxide, tetramethylammonium hydroxide, urea, ammonia, or a combination thereof, more preferably ammonia, to provide a pH of 2 to 12, preferably a pH of 4 to 10.

In an aspect, the contacting the gel-formation solution and the first solution comprises dropwise addition of the gel-formation solution to the first solution. In an aspect, a stoichiometric ratio of the organic acid to a total content of metal cations of the A-site precursor and the M-site precursor is between 1 to 1 and 10 to 1, more preferably between 1 to 1 and 5 to 1. In an aspect, the organic acid is aspartic acid and the stoichiometric ratio is between 1.5 to 1 and 3.5 to 1. In an aspect, the organic acid is ethylenediaminetetraacetic acid and the stoichiometric ratio is between 1 to 1 and 3 to 1, preferably 2.5 to 1. In an aspect, the organic acid is malic acid and the stoichiometric ratio is between 1 to 1 and 5 to 1, preferably 3.5 to 1.

In an aspect, the method may further comprise adding a glycol to the second solution, preferably wherein the glycol is ethylene glycol, and wherein a molar ratio of the organic acid to the glycol is 1 to 10, preferably 1 to 3, more preferably 1 to 1.5. In an aspect, the gel is a polymerized organic metal complex.

In an aspect, the method further comprises vacuum-treating the gel. The vacuum-treating the gel may be performed before heat-treating the gel. The vacuum-treating may comprise vacuum-treating at 0° C. to 110° C., preferably 30° C. to 100° C., more preferably 50° C. to 90° C. The vacuum-treating may comprise vacuum-treating at 0.001 kPa to 10 kPa, preferably 0.01 kPa to 1 kPa.

In an aspect, the heating comprises heating at 30° C. to 120° C., preferably 60° C. to 110° C., more preferably 80° C. to 100° C. In an aspect, the heat-treating comprises heat-treating at 300° C. to 1500° C., preferably 600° C. to 1000° C., more preferably 700° C. to 900° C. In an aspect, the heat-treating comprises heat-treating for 0.1 hours to 10 hours, preferably 0.5 hours to 5 hours, more preferably 1 hour to 4 hours. In an aspect, the heat-treating comprises a first heat-treating and a second heat-treating, wherein the first heat-treating comprises heat-treating at 30° C. to 600° C., preferably 190° C. to 500° C., and the second heat-treating comprises heat-treating at 190° C. to 1500° C., preferably 500° C. to 900° C. The first heat-treating may comprise heating at a ramp rate of 5° C./min, and the second heat-treating may comprise heating at a ramp rate of 1° C./min. In an aspect, the second heat-treating further comprises holding for 0.5 hours to 24 hours, preferably 1 to 4 hours at 190° C. to 1500° C., preferably 500° C. to 900° C.

In an aspect, the heat-treating comprises heat-treating in dry air, nitrogen, helium, argon, or hydrogen, more preferably in argon or nitrogen.

In an aspect, a method of preparing the compound comprises providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel formation solution; contacting the gel-formation solution and the first solution to form a second solution to provide a metal compound network; heating the metal compound network to provide a calcined product; and post-treating the calcined product to prepare the composition.

In an aspect, the method of preparing a catalyst with the supporting material comprises providing the above-described composition, and disposing the catalyst composition on a support to prepare a catalyst with the supporting material.

The composition described herein can be particularly useful as a catalyst composition. Accordingly a catalyst comprising the composition disclosed herein represents another aspect of the present disclosure. In an aspect, the catalyst can be an oxygen reduction reaction catalyst.

The catalyst can further comprise a support, wherein the composition described herein in on the support. The support can be any suitable material and can comprise, for example, carbon, a carbon-based (i.e., carbon-containing) material, carbide, nitride, silica, alumina, or a combination thereof. In some aspects, the support is a molecular sieve. In some aspects, the carbon-based material comprises activated carbon, carbon black, acetylene black, carbon nanotubes, carbon nanofibers, graphene, graphene oxide, graphite, or a combination thereof. In certain aspects, the carbon-based material may be doped with one or more heteroatoms including but not limited to boron, nitrogen, or sulfur. In certain aspects, the carbon-based material is a surface functionalized carbon-based material, including but limited to a surface functionalized activated carbon, carbon black, carbon nanotube, carbon nanofiber, graphene, graphene oxide, graphite, or a combination thereof. In certain aspects, the SSA of the carbon support is <100 m²/g, for example, 0.1 to 100 m²/g, 1 to 80 m²/g, or 10 to 60 m²/g. In certain aspects, the SSA of the carbon support is >100 m²/g, >500 m²/g, or >1000 m²/g, for example, 100 to 2000 m²/g, 500 to 1800 m²/g, or 1000 to 1500 m²/g. In a non-limiting example, the carbide supporting material is tungsten carbide. In a non-limiting example, the nitride supporting material is zirconium nitride. In a non-limiting example, the molecular sieve supporting material is zeolite.

In a specific aspect, the support comprises carbon, preferably amorphous carbon, more preferably a carbon having a specific surface area of greater than 0.1 m²/g, greater than 10 m²/g, preferably greater than 50 m²/g, more preferably greater than 100 m²/g, such as 10 m²/g to 2000 m²/g, or 10 m²/g to 1000 m²/g.

A gas diffusion electrode (GDE) represents another aspect of the present disclosure. A gas diffusion electrode may include the composition comprising the compound, or the catalyst comprising the composition on the supporting material. In an aspect, the gas diffusion electrode may comprise an active layer which may include the catalysts, supported catalysts, and binders. In some aspects, the active materials of the active layer may be formed by a mixture of catalyst particles or materials, conductive matrix and solvophobic materials, sintered, layered, or otherwise bonded to form a composite material. In various aspects, the active layer may be of any suitable construction or configuration, including but not limited to being constructed of carbon; fluoropolymers such as polytetrafluoroethylene (PTFE), perfluoroalkoxy alkane (PFA), fluorinated ethylene propylene (FEP), and/or polyvinylidene fluoride (PVDF); epoxies; conductive particles such as graphite, nickel, activated carbons, carbon fibers, carbon nanotubes, or graphene; fibers such as PTFE, polypropylene (PP), polyethylene (PE), SiO₂, or Al₂O₃; or any other suitable metal or alloy. In some aspects, the active layer may contain a second catalyst for promoting the reduction of oxygen. This second catalyst can be incorporated as independent particles or be supported on a conductive substrate, such as carbon black, activated carbon, or graphite, or other common catalysts such as platinum, platinum alloys, silver, silver alloy, manganese oxides, nickel, Raney nickel, nickel oxide, nickel hydroxide, nickel oxyhydroxide, cobalt oxide, perovskites, spinels, metal-nitrogen-carbon framework, heteroatom doped carbon, heteroatom doped carbon fibers, heteroatom doped carbon nanotubes, or heteroatom doped graphene.

In various aspects a barrier layer serves as a backing material for the active layer. The barrier layer facilitates gas transport to the catalyst surfaces from the gas flow channels. Although the barrier layer may vary across aspects, in some aspects the barrier layer may comprise a fluoropolymer. As an example, in various aspects, the barrier layer may comprise PTFE, which may in some aspects be thermo-mechanically expanded (also known as ePTFE, or Gore-Tex™). In other aspects, the barrier layer may comprise FEP, or any other fluoropolymer. The barrier layer may also be comprised of other binders such as polypropylene, polyethylene, polyamide, or an epoxy. In some aspects, the barrier layer may contain other materials, including, but not limited to, carbon, graphite, nickel, steel, alumina, titania, to increase conductivity and/or structural strength.

Electrically coupled to the active layer or the barrier layer may be a current collector, which may be configured to receive electrons from a load for consumption by the oxygen reduction reaction when the cell is in a discharge mode. The current collector may be of any appropriate construction or configuration, including but not limited to being a screen or flow field. It may be appreciated that the metal screen current collectors conventionally have holes therein that are on the order of 50 to 2500 μm, but are preferably in the range of 100 to 1000 μm, and may in some aspects be uniformly dispersed across its area. In various aspects the current collector may be constructed of metals or alloys such as but not limited to nickel or nickel alloys including nickel cobalt, nickel iron, nickel copper (i.e. Monel), or superalloys, copper or copper alloys, aluminum or aluminum alloys, titanium or titanium alloys, brass, bronze, carbon, graphite, platinum, silver, silver-palladium, carbon steel, stainless steel, or any other suitable metal or alloy, plated or clad metals (i.e. nickel plated copper or other such combination of base metal and plated or clad metal).

In an aspect, the catalyst loading may be 5 to 60 weight percent (wt %), 10 to 50 wt %, or 20 to 40 wt %, based on a total weight of the GDE.

In some aspects, the catalysts are used as the oxygen reduction reaction (ORR) catalysts in an alkaline electrolyte (pH≥14). In some aspects, the catalysts are used as in the active formulation of an electrode to facilitate ORR. In certain aspects, the said electrode to facilitate ORR is a gas diffusion electrode (GDE). In some aspects, the said GDE is used as the power generating positive electrode in a metal air battery with a metal negative electrode such as, but not limited to, lithium, sodium, potassium, calcium, magnesium, aluminum, iron, zinc, or a combination thereof. In some aspects, such a metal air battery is a primary battery. In some aspects, such a metal air battery is a mechanically rechargeable battery. In some aspects, such a metal air battery is a secondary battery. In certain aspects, the metal air battery is used in a bulk energy storage system.

In some aspects, such an ORR catalyst containing GDE is operated at a current density less than 1 A/cm² of the GDE, less than 200 mA/cm² of the GDE, less than 100 mA/cm² of the GDE, or less than 50 mA/cm² of the GDE. In some embodiments, such an ORR catalyst containing GDE is operated at a power density less than 0.1 W/cm² of the GDE, less than 0.05 W/cm² of the GDE, less than 0.02 W/cm² of the GDE, or less than 0.01 W/cm² of the GDE. In some embodiments, such an ORR catalyst containing GDE is operated at a temperature less than 120° C., less than 100° C., or less than 80° C.

The gas diffusion electrode may be used in a metal-air battery. The metal-air battery has a metal electrode (i.e., an anode or a negative electrode), the gas diffusion electrode (i.e., an air electrode, or a cathode, or a positive electrode), and an electrolyte that provides for ionic communication between the metal and air electrodes. The electrolyte contacts at least one of the negative electrode or the positive electrode. The metal electrode serves as the negative electrode of the battery cell, and the air electrode serves as the positive electrode. The metal-air battery may be a lithium-air, a sodium-air, a potassium-air, a calcium-air, a magnesium-air, an aluminum-air, a zinc-air, an iron-air, or a silicon-air battery.

Herein, “metal-air” batteries are understood to include as the “metal” any suitable chemical species which may be oxidized at an electrode of the battery when the battery is discharged, including without limitation alkali metals, alkaline earth metals, metal alloys, metalloids, such as Si or Ge, sulfur, boron, or phosphorus. At a counter electrode of the battery, molecular oxygen is reduced as the battery is discharged. Other variants of the metal-air battery include batteries wherein the species which is reduced at the air electrode (e.g., gas electrode) includes molecular species other than oxygen, and which may be supplied to the gas electrode as a gas or as molecular species dissolved in a liquid, including without limitation, carbon dioxide, carbon monoxide, nitrogen, nitrogen oxides, or sulfur oxides. As used herein, the term “air” refers to any suitable gas for use as an electrode active material in the metal-air battery, and may comprise oxygen, carbon dioxide, carbon monoxide, or air.

In an aspect, the metal-air battery comprises: a negative electrode; a positive electrode; and an electrolyte contacting at least one of the negative electrode or the positive electrode, wherein the positive electrode comprises the above-described catalyst composition. The negative electrode may comprise an alkali metal, an alkaline earth metal, a transition metal, a Group 13 metal, or a combination thereof. In an aspect, the electrode comprises a transition metal, preferably iron.

Also provided is a method to manufacture the metal-air battery. In an aspect, the metal electrode may be disposed on a current collector, and an electrolyte (e.g., solid electrolyte) may be disposed on the metal electrode, e.g., in a roll-to-roll process, to join the current collector, the metal electrode, and the electrolyte, and to provide a subassembly of the metal-air battery. Any of the current collector, the metal electrode, the solid electrolyte, and/or a sacrificial material such as a release film, may serve as a support or substrate upon which the current collector, the metal electrode, and/or the solid electrolyte are deposited, to provide the subassembly of the metal-air battery. The gas diffusion electrode comprising the catalyst may be combined with the subassembly to manufacture the metal-air battery.

The metal electrode of the metal-air battery may include any suitable metal. The metal may be an alkali metal, an alkaline-earth metal, a transition metal, a metalloid, a post-transition metal, or a combination thereof. In some aspects, the negative electrode may be an alkali metal or an alkaline earth metal. The alkali metal may be Li, Na, K, Rb, Cs, or a combination thereof, and the alkaline earth metal may be Mg, Ca, or a combination thereof. The transition metal may be iron, zinc, or the like, or a combination thereof. The post transition metal may be aluminum or the like. The metalloid may be silicon or the like. A combination including at least one of the foregoing may be used. For example, a metal of the negative electrode of the metal-air battery may include zinc, iron, or aluminum, the metal-air battery may be a zinc-air, iron-air, or aluminum-air battery, and the discharge product may form at the gas diffusion electrode.

The electrolyte of the metal-air battery may be any suitable liquid, may be aqueous or nonaqueous, or may be an ionic liquid. In an aspect, the metal-air battery may include an alkaline electrolyte. The aqueous electrolyte may include a hydroxide, such as an alkali metal hydroxide, such as lithium hydroxide, sodium hydroxide, potassium hydroxide, or a combination thereof, in water. The nonaqueous electrolyte may include a nonaqueous liquid, such as a C₁ to C₄ carbonate, a C₁ to C₄ alcohol, a C₁ to C₄ ketone, or a combination thereof, and any suitable salt, such as lithium borate, or the like. The ionic liquid may be an aluminum-alkali metal chloride, e.g., a chloroaluminate ionic liquid, such as an ionic liquid having a melting point below 100° C., e.g., 10° C. to 200° C., or 20° C. to 150° C. In an aspect, the electrolyte includes the working ion of the metal-air battery, and the working ion may correspond to the metal of the negative electrode of the metal-air battery and be contained in the electrolyte of the metal-air battery.

In an aspect the electrolyte may be a solid electrolyte. The solid electrolyte may be selected to conduct selected metal ion(s). The solid electrolyte may conduct lithium, sodium, aluminum, zinc, iron, or a combination thereof. The solid electrolyte may include solid polymer electrolytes (SPEs) having suitable lithium or sodium conductivity, such as a conductivity equivalent to polyethylene oxide (PEO) doped with a lithium salt such as lithium chloride. Copolymers and copolymers blends, including block copolymers, including PEO may also be used. The SPEs may be deposited on the current collector using any suitable process, such as a casting, coating, spraying, vapor deposition, or the like. In some aspects, casting a liquid solution including the SPE, or deposition of a vapor including the SPE, may be used. Other representative methods to dispose the SPE on the current collector include solvent casting, melt casting, dip coating, extrusion, co-extrusion, slot-die coating, spray coating, electrostatic spraying, electrophoretic deposition, ink jet deposition, three-dimensional printing, or the like, or a combination thereof. The SPEs may be disposed in the form of a liquid solution, a melt phase, liquid droplets, dry solid, or dry powder.

The solid electrolyte may include an inorganic solid electrolyte. Non-limiting examples include lithium ion and sodium ion conducting solid electrolytes, such as inorganic solid electrolyte having a garnet-type structure, such as lithium lanthanum titanium oxide (LLTO, e.g., Li₇La₃Zr₂O₁₂), doped variants of LLTO (e.g., LLZTO, Li_{6.75}La₃Zr_{1.7}Ta_{50.25}O₁₂), or derivatives thereof, or compositions or structures within the lithium superionic conductor (LiSICON) or sodium superionic conductor (NaSICON) families. As used herein, the term “garnet” or “garnet-type” means that the compound is isostructural with garnet, e.g., Mg₃Al₂(SiO₄)₃. For example, the solid electrolyte may include a beta-alumina, including sodium and/or potassium beta-alumina (e.g., (Na-β″-Al₂O₃ or (K-β″-Al₂O₃), sulfides such as lithium phosphorus sulfide (β-Li₃PS₄, LPS) or lithium germanium phosphorus sulfide (LGPS), antiperovskites such as Li₃OX or Li₂OHX, wherein X is a halogen, or compounds containing cluster ions such as those including NH₂, BH₄, or PS₄ groups, e.g., Na₃₋ₓO₁₋ₓ(NH₂)ₓ(BH₄) where 0<x<1, Li₃₋ₓO₁₋ₓ(NH₂)ₓ(BH₄) where 0<x<1, or an argyrodite material, e.g., a stoichiometric or a nonstoichiometric argyrodite material such as Li₆PS₅X, Li₆₋ₓPS₅₋ₓX₁₊ₓ, or Li₆₊ₓSiₓP₁₋ₓS₅X, where X is a halogen, such as Cl, Br, or I, and 0<x<1.

The current collector may include any suitable electrical conductor, and may include a transition metal, a metalloid, a post-transition metal, or a combination thereof. For example, the current collector may include copper, iron, titanium, zinc, aluminum, silicon, or a combination thereof. The current collector may include carbon, including graphitic carbon, glassy carbon, amorphous carbon, soot, carbon black, graphene, graphene oxide, carbon nanofibers, carbon nanotubes, or the like, or a combination thereof. In some aspects, the current collector may include an electronically conductive polymer, such as poly(3,4-ethylene dioxythiophene) (PEDOT). The current collector may include any suitable electronically conductive inorganic compound, such as a metal oxide, a metal carbide, a metal nitride, a metal oxycarbide, a metal oxynitride, or the like, or a combination thereof. Examples of such compounds include, but are not limited to, a copper oxide, a vanadium oxide, a tin oxide, a titanium carbide, a titanium nitride, or the like, or a combination thereof.

The term “electronically conductive” is understood to mean that the current collector material at its temperature of use has an electronic conductivity of greater than 10⁻⁶ Siemens per centimeter (S/cm), preferably greater than 10⁻³ S/cm, more preferably greater than 1 S/cm, and still more preferably greater than 10⁻³ S/cm, or 10⁻⁶ S/cm to 10³ S/cm, or 10⁻³ S/cm to 10³ S/cm.

### EXAMPLES

### Example 1: La_{0.4}Sr_{0.6}MnO_{3-δ}, 0≤δ≤0.5

Stoichiometric amounts of the acetate salts of lanthanum, strontium, and manganese were dissolved in water at room temperature under stirring to achieve a total metal cation concentration of 0.626 moles per liter (mol/L). After complete dissolution, malic acid powder was added under stirring at a molar ratio of 3.5 moles of malic acid to total moles of metal cations. The homogeneous solution was evaporated at 90° C. for about 1.5 hours under stirring and then further dehydrated at 120° C. The dehydrated gel was calcined at 800° C. for 2 hours under a dry airflow of 0.5 liters per minute (L/min). The metal oxide product was ground with a mortar and pestle.

### Example 2: La_{0.4}Sr_{0.6}MnO_{3-δ}, 0≤δ≤0.5

Stoichiometric amounts of the acetate salts of lanthanum, strontium, and manganese were dissolved in water at room temperature under stirring to achieve a total metal cation concentration of 0.78 mol/L. A separate solution was made, where ethylenediaminetetraacetic acid (EDTA) was added to water at a molar ratio of 2 moles of EDTA to total moles of metal cations, followed by the addition of 10 wt % ammonia in water solution to dissolve the acid fully. After complete dissolution, the acid solution was added to the acetate solution under stirring. Ethylene glycol was added to this final solution at a molar ratio of EDTA to ethylene glycol of 1 to 1. The homogeneous solution was evaporated at 90° C. for about 1.5 hours under stirring and then further dehydrated at 120° C. The dehydrated gel was calcined at 800° C. for 4 hours under a dry airflow of 0.5 L/min. The metal oxide product was ground with a mortar and pestle.

### Example 3: [La_{0.4}Sr_{0.6}]_{0.95}MnO_{3-δ}, 0≤δ≤0.5

Stoichiometric amounts of the acetate salts of lanthanum, strontium and manganese were dissolved in water at room temperature under stirring to achieve a total metal cation concentration of 0.21 mol/L. A separate solution was made, where aspartic acid was added to water at a molar ratio of 1.5 moles of aspartic acid to total moles of metal cations, followed by the addition of 10 wt % ammonia in water solution to dissolve the acid fully. After complete dissolution, the acid solution was added to the acetate solution under stirring. The homogeneous solution was evaporated at 90° C. for about 1.5 hours under stirring and then further dehydrated at 120° C. The dehydrated gel was calcined at 800° C. for 4 hours under a dry airflow of 0.5 L/min. The metal oxide product was ground with a mortar and pestle.

The product was characterized using X-ray diffraction (XRD). Peak position closely matched that of the JCPDS card 01-087-4968 for strontium doped lanthanum manganite.

The product was further characterized using BET. The BET specific surface area was measured as 21 m²/g. For comparison, the specific surface area of a commercial material with nominally the same composition was measured as 12 m²/g.

The product was further characterized using a 3-electrode, rotating disk electrode (RDE) setup. The catalyst ink was prepared by blending the catalyst with Vulcan XC72 in presence of water, isopropanol, and Nafion dispersion. The final catalyst loading on RDE was 0.15 mg/cm². A platinum coil electrode and a mercury/mercury oxide (MMO) electrode were used as the counter electrode and the reference electrode, respectively. The RDE testing was performed in 1 mol/L KOH solution saturated by oxygen at 25° C. The electrode rotation speed was maintained at 1600 rpm and the scan rate was set at 5 mV/s. The ORR activity of the product was measured as 23 A/g at 0.85V vs RHE. For comparison, the ORR activity of the commercial material with nominally the same composition was measured as 5 A/g at 0.85V vs RHE.

### Example 4: [La_{0.4}Sr_{0.6}]_{0.95}MnO_{3-δ}, 0≤δ≤0.5

Stoichiometric amounts of the acetate salts of lanthanum, strontium, and manganese were dissolved in water at room temperature under stirring to achieve a total metal cation concentration of 0.21 mol/L. After complete dissolution, malic acid powder was added under stirring at a molar ratio of 1.15 moles of malic acid to total moles of metal cations. The homogeneous solution was evaporated at 90° C. for about 1 hour under stirring and then further dehydrated at 120° C. The dehydrated gel was calcined at 700° C. for 4 hours under a dry airflow of 0.5 L/min. The metal oxide product was ground with a mortar and pestle.

The product was shown to be ORR active based on RDE testing using the same setup as described in Example 3.

The “mildly ground” product using mortar and pestle was further characterized using BET. The BET specific surface area was measured as 21.2 m²/g. A more intensive grinding using a ball mill for 10 minutes was shown to increase the specific surface area to 23.4 m²/g.

### Example 5: [La_{0.4}Sr_{0.6}]_{0.95}MnO_{3-δ}, 0≤δ≤0.5

Stoichiometric amounts of the acetate salts of lanthanum, strontium, and manganese were dissolved in water at room temperature under stirring to achieve a total metal cation concentration of 0.626 mol/L. Malic acid was added to the acetate solution at a molar ratio of 3.5 moles of malic acid to total moles of metal cations. Ethylene glycol is added to this final solution at a molar ratio of acid to ethylene glycol of 1 to 2. The homogeneous solution was evaporated at 90° C. for about 1.5 hours under stirring and then further dehydrated at 120° C. The dehydrated gel was calcined at 700° C. for 4 hours under a dry airflow of 0.5 L/min. The metal oxide product was ground with a mortar and pestle.

The product showed an average particle size less than 2 micrometers with high homogeneity based on scanning electron microscopy (SEM).

### Example 6: [La_{0.67}Sr_{0.33}]_{0.95}MnO_{3-δ}, 0≤δ≤0.5

Stoichiometric amounts of the acetate salts of lanthanum, strontium and manganese were dissolved in water at room temperature under stirring to achieve a total metal cation concentration of 0.21 mol/L. A separate solution was made, where aspartic acid was added to water at a molar ratio of 1.5 moles of aspartic acid to total moles of metal cations, followed by the addition of 10 wt % ammonia in water solution to dissolve the acid fully. After complete dissolution, the acid solution was added to the acetate solution under stirring. The homogeneous solution was evaporated at 90° C. for about 1.5 hours under stirring and then further dehydrated at 120° C. The dehydrated gel was calcined at 700° C. for 4 hours under a dry airflow of 0.5 L/min. The metal oxide product was ground with a mortar and pestle.

### Example 7: La_{0.7}Sr_{0.3}Mn_{0.9}Ni_{0.1}O_{3-δ}, 0≤δ≤0.5

Stoichiometric amounts of the acetate salts of lanthanum, strontium, manganese, and nickel were dissolved in water at room temperature under stirring to achieve a total metal cation concentration of 0.21 mol/L. After complete dissolution, citric acid monohydrate was added under stirring at a molar ratio of 1.5 moles of acid to total moles of metal cations. The homogeneous solution was evaporated at 90° C. for about 1.5 hours under stirring and then further dehydrated at 100° C. under vacuum. The dehydrated gel was calcined at 800° C. for 4 hours under a dry airflow of 0.5 L/min. The metal oxide product was ground with a mortar and pestle.

The product was tested using RDE and shown to be active towards ORR.

### Example 8: La_{0.4}Sr_{0.6}Mn_{0.9}Ni_{0.1}O_{3-δ}, 0≤δ≤0.5

Stoichiometric amounts of the acetate salts of lanthanum, strontium, manganese, or nickel were dissolved in water at room temperature under stirring to achieve a total metal cation concentration of 0.21 mol/L. A separate solution was made, where aspartic acid was added to water at a molar ratio of 1.5 moles of aspartic acid to total moles of metal cations, followed by the addition of 10 wt % ammonia in water solution to dissolve the acid fully. After complete dissolution, the acid solution was added to the acetate solution under stirring. The homogeneous solution was evaporated at 90° C. for about 1.5 hours under stirring and then further dehydrated at 120° C. The dehydrated gel was calcined at 800° C. for 4 hours under a dry airflow of 0.5 L/min. The metal oxide product was ground with a mortar and pestle.

The product was tested using RDE and shown to be active towards ORR.

### Example 9: La_{0.4}Sr_{0.6}Mn_{0.6}Ni_{0.4}O_{3-δ}, 0≤δ≤0.5

Stoichiometric amounts of the acetate salts of lanthanum, strontium, manganese, and nickel were dissolved in water at room temperature under stirring to achieve a total metal cation concentration of 0.626 mol/L. After complete dissolution, malic acid powder was added under stirring at a molar ratio of 3.5 moles of malic acid to total moles of metal cations. The homogeneous solution was evaporated at 90° C. for about 1.5 hours under stirring and then further dehydrated at 120° C. The dehydrated gel was calcined at 800° C. for 2 hours under a dry airflow of 0.5 L/min. The metal oxide product was ground with a mortar and pestle.

The product was tested using RDE and shown to be active towards ORR.

### Example 10: La_{0.4}Sr_{0.6}Mn_{0.8}Fe_{0.2}O_{3-δ}, 0≤δ≤0.5

Stoichiometric amounts of the acetate salts of lanthanum, strontium, manganese, and iron were dissolved in water at room temperature under stirring to achieve a total metal cation concentration of 0.626 mol/L. After complete dissolution, malic acid powder was added under stirring at a molar ratio of 3.5 moles of malic acid to total moles of metal cations. The homogeneous solution was evaporated at 90° C. for about 1.5 hours under stirring and then further dehydrated at 120° C. The dehydrated gel was calcined at 800° C. for 2 hours under a dry airflow of 0.5 L/min. The metal oxide product was ground with a mortar and pestle.

The product was tested using RDE and shown to be active towards ORR.

This disclosure further encompasses the following aspects, which are non-limiting.

Aspect 1: A composition comprising a compound of the formula AₓM_{y}O_{z}, wherein A comprises Ba, Ca, Cu, Dy, Er, Gd, La, Nd, Pr, Sm, Sr, Y, or Yb, or a combination thereof, M comprises Co, Cu, Fe, Mn, Ni, Ti, Sc, or P, or a combination thereof, and 0<x≤1, 0<y≤2, (3−δ)≤z≤(4−δ), and 0≤δ≤1.

Aspect 2: The composition of aspect 1, wherein A is an A-site element, M is an M-site element, z is 3-6, and wherein 0≤δ≤1, preferably 0≤δ≤0.5.

Aspect 3: The composition of any of aspects 1 to 2, wherein A is A1 and A2, wherein A1 and A2 are each independently Ba, Ca, Cu, Dy, Er, Gd, La, Nd, Pr, Sm, Sr, Y, or Yb, M is M1 and M2, wherein M1 and M2 are each independently Co, Cu, Fe, Mn, Ni, Ti, Sc, or P, and the composition has the formula [A1ₓ₁A2ₓ₂]ₐ[M1_{y1}M2_{y2}]_{b}O_{3-δ}, wherein x1+x2=1, 0<x1≤1, 0≤x2≤1, 0<a≤1, and y1+y2=1, 0<y1≤1, 0≤y2≤1, 0<b≤1, and 0≤δ≤0.5.

Aspect 4: The composition of aspect 3, wherein A1 is a lanthanum group element, A2 is a Group 2 element, M1 is a Group 7 element, and y2=0.

Aspect 5: The composition of aspects 3 or 4, wherein A1 is La, A2 is Sr, M1 is Mn, and b=1.

Aspect 6: The composition of any of aspects 3 to 5, wherein the compound is of the formula Laₓ₁Srₓ₂MnO_{3-δ}, wherein 0.1≤x1≤0.9, 0.1≤x2≤0.9, and 0≤δ≤0.5.

Aspect 7: The composition of any of aspects 3 to 6, wherein the compound comprises La_{0.1}Sr_{0.9}MnO_{3-δ}, La_{0.15}Sr_{0.85}MnO_{3-δ}, La_{0.2}Sr_{0.8}MnO_{3-δ}, La_{0.25}Sr_{0.75}MnO_{3-δ}, La_{0.3}Sr_{0.7}MnO_{3-δ}, La_{0.35}Sr_{0.65}MnO_{3-δ}, La_{0.4}Sr_{0.6}MnO_{3-δ}, La_{0.45}Sr_{0.55}MnO_{3-δ}, La_{0.5}Sr_{0.5}MnO_{3-δ}, La_{0.55}Sr_{0.45}MnO_{3-δ}, La_{0.6}Sr_{0.4}MnO_{3-δ}, La_{0.65}Sr_{0.45}MnO_{3-δ}, La_{0.7}Sr_{0.3}MnO_{3-δ}, La_{0.75}Sr_{0.25}MnO_{3-δ}, La_{0.8}Sr_{0.2}MnO_{3-δ}, La_{0.85}Sr_{0.15}MnO_{3-δ}, or La_{0.9}Sr_{0.1}MnO_{3-δ}, wherein δ is each independently 0≤δ≤0.5.

Aspect 8: The composition of aspects 3 or 4, wherein A1 is La, A2 is Sr, a=0.95, M1 is Mn, and b=1.

Aspect 9: The composition of aspect 8, wherein the compound is of the nominal formula [Laₓ₁Srₓ₂]_{0.95}MnO_{3-δ}, wherein 0.1≤x1≤0.9, 0.1≤x2≤0.9, and 0≤δ≤0.5.

Aspect 10: The composition of aspects 8 or 9, wherein the compound comprises a nominal stoichiometry of: [La_{0.1}Sr_{0.9}]_{0.95}MnO_{3-δ}, [La_{0.15}Sr_{0.85}]_{0.95}MnO_{3-δ}, [La_{0.2}Sr_{0.8}]_{0.95}MnO_{3-δ}, [La_{0.25}Sr_{0.75}]_{0.95}MnO_{3-δ}, [La_{0.3}Sr_{0.7}]_{0.95}MnO_{3-δ}, [La_{0.35}Sr_{0.65}]_{0.95}MnO_{3-δ}, [La_{0.4}Sr_{0.6}]_{0.95}MnO_{3-δ}, [La_{0.45}Sr_{0.85}]_{0.95}MnO_{3-δ}, [La_{0.5}Sr_{0.5}]_{0.95}MnO_{3-δ}, [La_{0.85}Sr_{0.45}]_{0.95}MnO_{3-δ}, [La_{0.6}Sr_{0.4}]_{0.95}MnO_{3-δ}, [La_{0.65}Sr_{0.35}]_{0.95}MnO_{3-δ}, [La_{0.7}Sr_{0.3}]_{0.95}MnO_{3-δ}, [La_{0.7}5Sr_{0.25}]_{0.95}MnO_{3-δ}, [La_{0.8}Sr_{0.2}]_{0.95}MnO_{3-δ}, [La_{0.85}Sr_{0.15}]_{0.95}MnO_{3-δ}, [La_{0.9}Sr_{0.1}]_{0.95}MnO_{3-δ}, wherein δ is each independently 0≤δ≤0.5.

Aspect 11: The composition of aspects 3 or 4, wherein A1 is La, A2 is Sr, a=0.9, M1 is Mn, and b=1.

Aspect 12: The composition of aspect 11, wherein the compound is of the nominal formula [Laₓ₁Srₓ₂]_{0.9}MnO_{3-δ}, wherein 0.1≤x1≤0.9, 0.1≤x2≤0.9, and 0≤δ≤0.5.

Aspect 13: The composition of aspect 11, wherein the compound comprises a nominal stoichiometry of: [La_{0.1}Sr_{0.9}]_{0.9}MnO_{3-δ}, [La_{0.15}Sr_{0.85}]_{0.9}MnO_{3-δ}, [La_{0.2}Sr_{0.8}]_{0.9}MnO_{3-δ}, [La_{0.25}Sr_{0.75}]_{0.9}MnO_{3-δ}, [La_{0.3}Sr_{0.7}]_{0.9}MnO_{3-δ}, [La_{0.35}Sr_{0.65}]_{0.9}MnO_{3-δ}, [La_{0.4}Sr_{0.6}]_{0.9}MnO_{3-δ}, [La_{0.45}Sr_{0.85}]_{0.9}MnO_{3-δ}, [La_{0.8}Sr_{0.8}]_{0.9}MnO_{3-δ}, [La_{0.85}Sr_{0.45}]_{0.9}MnO_{3-δ}, [La_{0.6}Sr_{0.4}]_{0.9}MnO_{3-δ}, [La_{0.65}Sr_{0.35}]_{0.9}MnO_{3-δ}, [La_{0.7}Sr_{0.3}]_{0.9}MnO_{3-δ}, [La_{0.7}5Sr_{0.25}]_{0.9}MnO_{3-δ}, [La_{0.8}Sr_{0.2}]_{0.9}MnO_{3-δ}, [La_{0.85}Sr_{0.15}]_{0.9}MnO_{3-δ}, [La_{0.9}Sr_{0.1}]_{0.9}MnO_{3-δ}, wherein δ is each independently 0≤δ≤0.5.

Aspect 14: The composition of aspect 3, wherein A1 is a lanthanum group element, A2 is a Group 2 element, M1 is a Group 7 element, and M2 is a Group 8 element.

Aspect 15: The composition of aspect 14, wherein A1 is La, A2 is Sr, M1 is Mn, M2 is Fe, and b=1.

Aspect 16: The composition of aspect 15, wherein the compound is of the nominal formula [Laₓ₁Srₓ₂]ₐ[Mn_{y1}Fe_{y2}]O_{3-δ}, wherein x1+x2=1, 0.1≤x1≤0.9, 0.1≤x2≤0.9, 0.9≤a≤1, y1+y2=1, 0.05≤y1≤0.95, 0.05≤y2≤0.95, and 0≤δ≤0.5.

Aspect 17: The composition of aspect 3, wherein A1 is a lanthanum group element, A2 is a Group 2 element, M1 is a Group 7 element, and M2 is a Group 9 element.

Aspect 18: The composition of aspect 17, wherein A1 is La, A2 is Sr, M1 is Mn, M2 is Co, and b=1.

Aspect 19: The composition of aspect 18, wherein the compound is of the nominal formula [Laₓ₁Srₓ₂]ₐ[Mn_{y1}Co_{y2}]O_{3-δ}, wherein x1+x2=1, 0.1≤x1≤0.9, 0.1≤x2≤0.9, 0.9≤a≤1, y1+y2=1, 0.05≤y1≤0.95, 0.05≤y2≤0.95, and 0≤δ≤0.5.

Aspect 20: The composition of aspect 3, wherein A1 is a lanthanum group element, A2 is a Group 2 element, M1 is a Group 7 element, and M2 is a Group 10 element.

Aspect 21: The composition of aspect 20, wherein A1 is La, A2 is Sr, M1 is Mn, M2 is Ni, and b=1.

Aspect 22: The composition of aspect 21, wherein the compound is of the nominal formula [Laₓ₁Srₓ₂]ₐ[Mn_{y1}Ni_{y2}]O_{3-δ}, wherein x1+x2=1, 0.1≤x1≤0.9, 0.1≤x2≤0.9, 0.9≤a≤1, y1+y2=1, 0.05≤y1≤0.95, 0.05≤y2≤0.95, and 0≤δ≤0.5.

Aspect 23: The composition of any of aspects 1 to 22, wherein the composition has a perovskite structure.

Aspect 24: The composition of aspect 23, wherein the composition has peaks centered at 2θ values of 31.6° to 33.9°, 39.4° to 41.6°, and 46.2° to 48.2°, when analyzed by X-ray diffraction using CuKα radiation, preferably wherein the peaks have a full-width-at-half-maximum of 0.30 to 1.30.

Aspect 25; The composition of any of aspects 1 to 24, wherein the compound has a specific surface area of greater than 0.1 m²/g, greater than 10 m²/g, preferably greater than 50 m2/g, more preferably greater than 100 m²/g, such as 0.1 m²/g to 200 m²/g, when determined by the Brunauer-Emmett-Teller adsorption method (“BET”), preferably as set forth in ISO 9277 or in ASTM D3663.

Aspect 26: An oxygen reduction reaction catalyst comprising the composition of any of aspects 1 to 25.

Aspect 27: The oxygen reduction reaction catalyst of aspect 26, further comprising a support, wherein the composition is on the support.

Aspect 28: The oxygen reduction reaction catalyst of aspect 26 or 27, wherein the catalyst has peaks centered at 2θ values of 31.6° to 33.9°, 39.4° to 41.6°, and 46.2° to 48.2°, when analyzed by X-ray diffraction using CuKα radiation, preferably wherein the peaks have a full-width-at-half-maximum of 0.3° to 1.3°.

Aspect 29: The oxygen reduction reaction catalyst of any of aspects 26 to 28, wherein the catalyst has a specific surface area of greater than 0.1 m²/g, greater than 10 m²/g, preferably greater than 50 m²/g, more preferably greater than 100 m²/g, such as 0.1 m²/g to 200 m²/g, when determined by the Brunauer-Emmett-Teller adsorption method (“BET”), preferably as set forth in ISO 9277 or in ASTM D3663.

Aspect 30: The oxygen reduction reaction catalyst of any of aspects 26 to 29, wherein the support comprises carbon, preferably amorphous carbon, more preferably a carbon having a specific surface area of greater than 0.1 m²/g, greater than 10 m²/g, preferably greater than 100 m²/g, more preferably greater than 1000 m²/g, such as 10 m²/g to 2000 m²/g.

Aspect 31: The oxygen reduction reaction catalyst of any of aspects 26 to 30, further comprising an alkaline electrolyte contacting the catalyst.

Aspect 32: A gas diffusion electrode comprising an oxygen reduction reaction catalyst comprising the composition of any of aspects 1 to 25.

Aspect 33: The gas diffusion electrode of aspect 32, wherein the gas diffusion electrode is effective to operate for 1000 hours or greater with an electrode voltage of at least 0.65 V vs reversible hydrogen electrode (RHE) at a cell temperature of 10 to 80° C. in an alkaline electrolyte with pH>14.

Aspect 34: The gas diffusion electrode of aspect 33, wherein the gas diffusion electrode is effective to operate at a current density of 200 mA/cm² or less with an electrode voltage of at least 0.65 V vs reversible hydrogen electrode (RHE) at a cell temperature of 10 to 80° C. in an alkaline electrolyte with pH>14.

Aspect 35: A metal-air battery comprising: a negative electrode comprising a metal; a positive electrode comprising a gas diffusion electrode; and an electrolyte contacting at least one of the negative electrode or the positive electrode, wherein the positive electrode comprises the composition of any of aspects 1 to 25.

Aspect 36: The battery of aspect 35, wherein the metal of the negative electrode comprises an alkali metal, an alkaline earth metal, a transition metal, a Group 13 metal, or a combination thereof.

Aspect 37: The battery of aspect 35 or 36, wherein the metal of the negative electrode comprises a transition metal, preferably aluminum, iron, or zinc.

Aspect 38: A method of preparing the composition of any of aspects 1 to 25, the method comprising: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel-formation solution; contacting the gel-formation solution and the first solution to form a second solution; heating the second solution to evaporate the water and provide a gel; heat-treating the gel to prepare the compound; and post-treating the compound to provide the composition.

Aspect 39: The method of aspect 38, wherein the A-site precursor is a sulfate, formate, acetate, hexafluorophosphate, chloride, tetrafluoroborate, citrate, nitrate, triflate, bicarbonate, or a combination thereof.

Aspect 40: The method of aspect 38 or 39, wherein the M-site precursor is a sulfate, formate, acetate, hexafluorophosphate, chloride, tetrafluoroborate, citrate, nitrate, triflate, bicarbonate, or a combination thereof.

Aspect 41: The method of any of aspects 38 to 40, wherein the providing a gel-formation solution comprises dissolving an organic acid in water, preferably wherein the organic acid is an acetic acid, an aspartic acid, a carboxylic acid, an ethylenediaminetetraacetic acid, a malic acid, or a combination thereof.

Aspect 42: The method of aspect 41, further comprising adding a base to the gel-formation solution, preferably sodium hydroxide, potassium hydroxide, tetramethylammonium hydroxide, urea, ammonia, or a combination thereof, to dissolve the acid.

Aspect 43: The method of aspect 41, wherein the contacting the gel-formation solution and the first solution comprises addition of the gel-formation solution to the first solution at a rate of 1 to 10 milliliters per second.

Aspect 44: The method of any of aspects 41 to 43, wherein a stoichiometric ratio of the organic acid to a total content of metal cations of the A-site precursor and the M-site precursor is between 1 to 1 and 10 to 1, preferably between 1 to 1 and 5 to 1.

Aspect 45: The method of any of aspects 41 to 44, wherein the organic acid is aspartic acid and the stoichiometric ratio is between 1.5 to 1 and 3.5 to 1, wherein the organic acid is ethylenediaminetetraacetic acid and the stoichiometric ratio is between 1 to 1 and 3 to 1, preferably 2.5 to 1, or wherein the organic acid is malic acid and the stoichiometric ratio is between 1 to 1 and 5 to 1.

Aspect 46: The method of any of aspects 38 to 45, further comprising adding a base to the second solution, preferably sodium hydroxide, potassium hydroxide, tetramethylammonium hydroxide, urea, ammonia, or a combination thereof.

Aspect 47: The method of aspect 46, wherein adding the base to the second solution is at a rate of 1 to 1000 milliliters per second per 1000 milliliters of the first solution.

Aspect 48: The method of any of aspects 41 to 47, further comprising adding a glycol to the second solution, preferably wherein the glycol is ethylene glycol, and wherein a molar ratio of the organic acid to the glycol is 1 to 10, preferably 1 to 3, more preferably 1 to 1.5.

Aspect 49: The method of aspect 48, wherein the gel is a polymerized organic metal complex.

Aspect 50: The method of any of aspects 41 to 49, further comprising vacuum-treating the gel before the heat-treating of the gel.

Aspect 51: The method of aspect 50, wherein the vacuum-treating comprises vacuum-treating at 0° C. to 110° C., preferably 30° C. to 100° C., more preferably 50° C. to 90° C.

Aspect 52: The method of aspect 50 or 51, wherein the vacuum-treating comprises vacuum-treating at 0.001 kPa to 10 kPa, preferably 0.01 kPa to 1 kPa.

Aspect 53: The method of any of aspects 41 to 52, wherein the heating comprises heating at 30° C. to 120° C., preferably 60° C. to 110° C., more preferably 80° C. to 100° C.

Aspect 54: The method of any of aspects 41 to 53, wherein the heat-treating comprises heat-treating at 300° C. to 1500° C., preferably 600° C. to 1000° C., more preferably 700° C. to 900° C.

Aspect 55: The method of aspect 54, wherein the heat-treating comprises heat-treating for 0.1 hours to 10 hours, preferably 0.5 hours to 5 hours, more preferably 1 hour to 4 hours.

Aspect 56: The method of any of aspects 41 to 55, wherein the heat-treating comprises a first heat-treating and a second heat-treating, wherein the first heat-treating comprises heat-treating at 30° C. to 600° C., preferably 190° C. to 500° C., and the second heat-treating comprises heat-treating at 190° C. to 1500° C., preferably 500° C. to 900° C.

Aspect 57: The method of any of aspects 41 to 56, wherein the heat-treating comprises heat-treating in dry air, nitrogen, helium, argon, or hydrogen, preferably in argon or nitrogen.

Aspect 58: The method of aspect 56 or 57, wherein the first heat-treating comprises heating at a ramp rate of 1 to 10° C./min, and the second heat-treating comprises heating at a ramp rate of 0.5 to 5° C./min.

Aspect 59: The method of any of aspects 56 to 58, wherein the second heat-treating further comprises holding for 0.5 hours to 24 hours, preferably 1 to 4 hours at 190° C. to 1500° C., preferably 500° C. to 900° C.

Aspect 60: The method of any of aspects 41 to 59, wherein the method is a solution based synthesis comprising a sol-gel process, a reverse homogeneous precipitation process, or a reverse micelle process.

Aspect 61: A method of preparing the composition of any of aspects 1 to 25, the method comprising: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel-formation solution, wherein the gel formation solution is an organic acid in water, preferably wherein the organic acid is an acetic acid, an aspartic acid, a carboxylic acid, an ethylenediaminetetraacetic acid, a malic acid, or a combination thereof; contacting the gel-formation solution and the first solution to form a second solution; heating the second solution to evaporate the water and provide a gel; heat-treating the gel to prepare the compound; and post-treating the compound to provide the composition.

Aspect 62: The method of aspect 61, further comprising adding a base to the second solution, preferably sodium hydroxide, potassium hydroxide, tetramethylammonium hydroxide, urea, ammonia, or a combination thereof.

Aspect 63: A method of preparing the composition of any of aspects 1 to 25, the method comprising: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel-formation solution, wherein the gel formation solution is provided by dissolving an organic acid in water, preferably wherein the organic acid is an acetic acid, an aspartic acid, a carboxylic acid, an ethylenediaminetetraacetic acid, a malic acid, or a combination thereof, and adding a base to the gel-formation solution, preferably sodium hydroxide, potassium hydroxide, tetramethylammonium hydroxide, urea, ammonia, or a combination thereof, to dissolve the acid; contacting the gel-formation solution and the first solution to form a second solution; heating the second solution to evaporate the water and provide a gel; heat-treating the gel to prepare the compound; and post-treating the compound to provide the composition.

Aspect 65: A method of preparing the composition of any of aspects 1 to 25, the method comprising: providing an A-site precursor comprising a compound comprising Ba, Ca, Cu, Dy, Er, Gd, La, Nd, Pr, Sm, Sr, Y, or Yb, or a combination thereof; providing an M-site precursor comprising Co, Cu, Fe, Mn, Ni, Ti, Sc, P, or a combination thereof; contacting the A-site precursor, the M-site precursor, and water to form a first solution; providing a gel formation solution; contacting the gel-formation solution and the first solution to form a second solution to provide a metal compound network; heating the metal compound network to provide a calcined product; and post-treating the calcined product to prepare the composition.

Aspect 66: A method of preparing a catalyst, the method comprising: providing the composition of any of aspects 1 to 25 to prepare the catalyst.

Aspect 67: The method of aspect 66, further comprising disposing the composition on a support to prepare the catalyst.

Aspect 68: A method of preparing a gas diffusion electrode, the method comprising: providing an electrode; providing the catalyst comprising the composition of any of aspects 1 to 25; and disposing the catalyst on the electrode to prepare the gas diffusion electrode.

Aspect 69: A method of preparing a metal-air battery, the method comprising: providing a negative electrode comprising a metal; providing a positive electrode comprising the gas diffusion electrode of any of aspects 32 to 34; and contacting the negative electrode and the positive electrode with an electrolyte to prepare the metal-air battery.

The compositions, methods, and articles can alternatively include, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspects”, “an aspect”, and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination including at least one of the listed components or properties optionally together with a like or equivalent component or property not listed.

It will be understood that when an element is referred to as being “on” another element, it can be directly on the other element or intervening elements may be present therebetween. In contrast, when an element is referred to as being “directly on” another element, there are no intervening elements present.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower” can therefore encompass both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents. In addition, many modifications may be made to adapt a particular situation or material to the teachings of the present disclosure without departing from the essential scope thereof. Therefore, it is intended that the present disclosure not be limited to the particular aspect disclosed as the best mode contemplated for carrying out this present disclosure, but that the present disclosure will include all aspects falling within the scope of the claims.

1. A composition comprising
a compound of the formula A_{X}M_{y}O_{Z}, wherein
A comprises Ba, Ca, Cu, Dy, Er, Gd, La, Nd, Pr, Sm, Sr, Y, or Yb, or a combination thereof,
M comprises Co, Cu, Fe, Mn, Ni, Ti, Sc, or P, or a combination thereof, and
0<x≤1, 0<y≤2, (3−δ)≤z≤(4−δ), and 0≤δ≤1.

2. The composition of claim 1, wherein A is an A-site element, M is an M-site element, z is 3−δ, and wherein 0≤δ<1.

3. The composition of claim 1, wherein
A is A1 and A2, wherein A1 and A2 are each independently Ba, Ca, Cu, Dy, Er, Gd, La, Nd, Pr, Sm, Sr, Y, or Yb,
M is M1 and M2, wherein M1 and M2 are each independently Co, Cu, Fe, Mn, Ni, Ti, Sc, or P, and
the composition has the formula [A1ₓ₁A2ₓ₂]ₐ[M1_{y1}M2_{y2}]_{b}O_{3-δ}, wherein x1+x2=1, 0<x1≤1, 0≤x2≤1, 0<a≤1, and y1+y2=1, 0<y1≤1, 0≤y2≤1, 0<b≤1, and 0≤δ≤0.5.

4. The composition of claim 3, wherein A1 is a lanthanum group element, A2 is a Group 2 element, M1 is a Group 7 element, and y2=0.

5. The composition of claim 4, wherein the compound is of the formula Laₓ₁Srₓ₂MnO_{3-δ}, wherein 0.1≤x1≤0.9, 0.1≤x2≤0.9, and 0≤δ≤0.5.

6. The composition of claim 5, wherein the compound comprises La_{0.1}Sr_{0.9}MnO_{3-δ}, La_{0.15}Sr_{0.85}MnO_{3-δ}, La_{0.2}Sr_{0.8}MnO_{3-δ}, La_{0.25}Sr_{0.75}MnO_{3-δ}, La_{0.3}Sr_{0.7}MnO_{3-δ}, La_{0.35}Sr_{0.65}MnO_{3-δ}, La_{0.4}Sr_{0.6}MnO_{3-δ}, La_{0.45}Sr_{0.55}MnO_{3-δ}, La_{0.5}Sr_{0.5}MnO_{3-δ}, La_{0.55}Sr_{0.45}MnO_{3-δ}, La_{0.6}Sr_{0.4}MnO_{3-δ}, La_{0.65}Sr_{0.45}MnO_{3-δ}, La_{0.7}Sr_{0.3}MnO_{3-δ}, La_{0.75}Sr_{0.25}MnO_{3-δ}, La_{0.8}Sr_{0.2}MnO_{3-δ}, La_{0.85}Sr_{0.15}MnO_{3-δ}, or La_{0.9}Sr_{0.1}MnO_{3-δ}, wherein δ is each independently 0≤δ≤0.5.

7. The composition of claim 3, wherein A1 is La, A2 is Sr, a=0.95, M1 is Mn, and b=1, and wherein the compound is of the nominal formula [Laₓ₁Srₓ₂]_{0.95}MnO_{3-δ}, wherein 0.1≤x1≤0.9, 0.1≤x2≤0.9, and 0≤δ≤0.5.

8. The composition of claim 7, wherein the compound comprises a nominal stoichiometry of: [La_{0.1}Sr_{0.9}]_{0.95}MnO_{3-δ}, [La_{0.15}Sr_{0.85}]_{0.95}MnO_{3-δ}, [La_{0.2}Sr_{0.8}]_{0.95}MnO_{3-δ}, [La_{0.25}Sr_{0.75}]_{0.95}MnO_{3-δ}, [La_{0.3}Sr_{0.7}]_{0.95}MnO_{3-δ}, [La_{0.35}Sr_{0.65}]_{0.95}MnO_{3-δ}, [La_{0.4}Sr_{0.6}]_{0.95}MnO_{3-δ}, [La_{0.45}Sr_{0.85}]_{0.95}MnO_{3-δ}, [La_{0.5}Sr_{0.5}]_{0.95}MnO_{3-δ}, [La_{0.85}Sr_{0.45}]_{0.95}MnO_{3-δ}, [La_{0.6}Sr_{0.4}]_{0.95}MnO_{3-δ}, [La_{0.65}Sr_{0.35}]_{0.95}MnO_{3-δ}, [La_{0.7}Sr_{0.3}]_{0.95}MnO_{3-δ}, [La_{0.7}5Sr_{0.25}]_{0.95}MnO_{3-δ}, [La_{0.8}Sr_{0.2}]_{0.95}MnO_{3-δ}, [La_{0.85}Sr_{0.15}]_{0.95}MnO_{3-δ}, [La_{0.9}Sr_{0.1}]_{0.95}MnO_{3-δ}, wherein δ is each independently 0≤δ≤0.5.

9. The composition of claim 3, wherein A1 is La, A2 is Sr, a=0.9, M1 is Mn, and b=1, and the compound is of the nominal formula [Laₓ₁Srₓ₂]_{0.9}MnO_{3-δ}, wherein 0.1≤x1≤0.9, 0.1≤x2≤0.9, and 0≤δ≤0.5.

10. The composition of claim 9, wherein the compound comprises a nominal stoichiometry of: [La_{0.1}Sr_{0.9}]_{0.9}MnO_{3-δ}, [La_{0.15}Sr_{0.85}]_{0.9}MnO_{3-δ}, [La_{0.2}Sr_{0.8}]_{0.9}MnO_{3-δ}, [La_{0.25}Sr_{0.75}]_{0.9}MnO_{3-δ}, [La_{0.3}Sr_{0.7}]_{0.9}MnO_{3-δ}, [La_{0.35}Sr_{0.65}]_{0.9}MnO_{3-δ}, [La_{0.4}Sr_{0.6}]_{0.9}MnO_{3-δ}, [La_{0.45}Sr_{0.85}]_{0.9}MnO_{3-δ}, [La_{0.5}Sr_{0.5}]_{0.9}MnO_{3-δ}, [La_{0.85}Sr_{0.45}]_{0.9}MnO_{3-δ}, [La_{0.6}Sr_{0.4}]_{0.9}MnO_{3-δ}, [La_{0.65}Sr_{0.35}]_{0.9}MnO_{3-δ}, [La_{0.7}Sr_{0.3}]_{0.9}MnO_{3-δ}, [La_{0.7}5Sr_{0.25}]_{0.9}MnO_{3-δ}, [La_{0.8}Sr_{0.2}]_{0.9}MnO_{3-δ}, [La_{0.85}Sr_{0.15}]_{0.9}MnO_{3-δ}, [La_{0.9}Sr_{0.1}]_{0.9}MnO_{3-δ}, wherein δ is each independently 0≤δ≤0.5.

11. The composition of claim 3, wherein A1 is a lanthanum group element, A2 is a Group 2 element, M1 is a Group 7 element, and M2 is a Group 8 element.

12. The composition of claim 11, wherein the compound is of the nominal formula [Laₓ₁Srₓ₂]ₐ[Mn_{y1}Fe_{y2}]O_{3-δ}, wherein x1+x2=1, 0.1≤x1≤0.9, 0.1≤x2≤0.9, 0.9≤a≤1, y1+y2=1, 0.05≤y1≤0.95, 0.05≤y2≤0.95, and 0≤δ≤0.5.

13. The composition of claim 3, wherein A1 is a lanthanum group element, A2 is a Group 2 element, M1 is a Group 7 element, and M2 is a Group 9 element.

14. The composition of claim 13, wherein the compound is of the nominal formula [Laₓ₁Srₓ₂]ₐ[Mn_{y1}Co_{y2}]O_{3-δ}, wherein x1+x2=1, 0.1≤x1≤0.9, 0.1≤x2≤0.9, 0.9≤a≤1, y1+y2=1, 0.05≤y1≤0.95, 0.05≤y2≤0.95, and 0≤δ≤0.5.

15. The composition of claim 3, wherein A1 is a lanthanum group element, A2 is a Group 2 element, M1 is a Group 7 element, and M2 is a Group 10 element.

16. The composition of claim 15, wherein the compound is of the nominal formula [Laₓ₁Srₓ₂]ₐ[Mn_{y1}Ni_{y2}]O_{3-δ}, wherein x1+x2=1, 0.1≤x1≤0.9, 0.1≤x2≤0.9, 0.9≤a≤1, y1+y2=1, 0.05≤y1≤0.95, 0.05≤y2≤0.95, and 0≤δ≤0.5.

17. The composition of claim 1, wherein the composition has a perovskite structure.

18. The composition of claim 16, wherein the composition has peaks centered at 2θ values of 31.6° to 33.9°, 39.4° to 41.6°, and 46.2° to 48.2°, when analyzed by X-ray diffraction using CuKα radiation.

19. The composition of claim 1, wherein the compound has a specific surface area of greater than 0.1 m²/g, when determined by the Brunauer-Emmett-Teller adsorption method (“BET”).

20. An oxygen reduction reaction catalyst comprising the composition of claim 1, optionally further comprising a support, wherein the composition is on the support.

21. The oxygen reduction reaction catalyst of claim 20, wherein the catalyst has peaks centered at 2θ values of 31.6° to 33.9°, 39.4° to 41.6°, and 46.2° to 48.2°, when analyzed by X-ray diffraction using CuKα radiation.

22. The oxygen reduction reaction catalyst of claim 20, wherein the catalyst has a specific surface area of greater than 0.1 m²/g, when determined by the Brunauer-Emmett-Teller adsorption method (“BET”).

23. The oxygen reduction reaction catalyst of claim 20, wherein the support comprises carbon.

24. The oxygen reduction reaction catalyst of claim 20, further comprising an alkaline electrolyte contacting the catalyst.

25. A gas diffusion electrode comprising an oxygen reduction reaction catalyst comprising the composition of claim 1.

26. The gas diffusion electrode of claim 25,
wherein the gas diffusion electrode is effective to operate for 1000 hours or greater with an electrode voltage of at least 0.65 V vs reversible hydrogen electrode (RHE) at a cell temperature of 10 to 80° C. in an alkaline electrolyte with pH>14; or
wherein the gas diffusion electrode is effective to operate at a current density of 200 mA/cm² or less with an electrode voltage of at least 0.65 V vs reversible hydrogen electrode (RHE) at a cell temperature of 10 to 80° C. in an alkaline electrolyte with pH>14.

27. A metal-air battery comprising:
a negative electrode comprising a metal;
a positive electrode comprising a gas diffusion electrode; and
an electrolyte contacting at least one of the negative electrode or the positive electrode,
wherein the positive electrode comprises the composition of claim 1.

28. The battery of claim 27, wherein the metal of the negative electrode comprises an alkali metal, an alkaline earth metal, a transition metal, a Group 13 metal, or a combination thereof.

29. The battery of claim 27, wherein the metal of the negative electrode comprises a transition metal, preferably aluminum, iron, or zinc.

30. A method of preparing the composition of claim 1, the method comprising:
providing an A-site precursor comprising a compound comprising Ba, Ca, Cu, Dy, Er, Gd, La, Nd, Pr, Sm, Sr, Y, or Yb, or a combination thereof;
providing an M-site precursor comprising Co, Cu, Fe, Mn, Ni, Ti, Sc, P, or a combination thereof;
contacting the A-site precursor, the M-site precursor, and water to form a first solution;
providing a gel-formation solution;
contacting the gel-formation solution and the first solution to form a second solution;
heating the second solution to evaporate the water and provide a gel;
heat-treating the gel to prepare the compound; and
post-treating the compound to provide the composition.

31. The method of claim 30, wherein
the A-site precursor is a sulfate, formate, acetate, hexafluorophosphate, chloride, tetrafluoroborate, citrate, nitrate, triflate, bicarbonate, or a combination thereof; and
the M-site precursor is a sulfate, formate, acetate, hexafluorophosphate, chloride, tetrafluoroborate, citrate, nitrate, triflate, bicarbonate, or a combination thereof.

32. The method of claim 30, wherein the providing a gel-formation solution comprises dissolving an organic acid in water.

33. The method of claim 32, further comprising adding a base to the gel-formation solution.

34. The method of claim 30, wherein the contacting the gel-formation solution and the first solution comprises addition of the gel-formation solution to the first solution at a rate of 1 to 1000 milliliters per second per 1000 milliliters of the first solution.

35. The method of claim 32, wherein a stoichiometric ratio of the organic acid to a total content of metal cations of the A-site precursor and the M-site precursor is between 1 to 1 and 10 to 1.

36. The method of claim 32, wherein the organic acid is aspartic acid and the stoichiometric ratio is between 1.5 to 1 and 3.5 to 1, wherein the organic acid is ethylenediaminetetraacetic acid and the stoichiometric ratio is between 1 to 1 and 3 to 1, preferably 2.5 to 1, or wherein the organic acid is malic acid and the stoichiometric ratio is between 1 to 1 and 5 to 1.

37. The method of claim 30, further comprising adding a base to the second solution.

38. The method of claim 37, wherein adding the base to the second solution is at a rate of 1 to 1000 milliliters per second per 1000 milliliters of the first solution.

39. The method of claim 32, further comprising adding a glycol to the second solution.

40. The method of claim 39, wherein the gel is a polymerized organic metal complex.

41. The method of claim 30, further comprising vacuum-treating the gel before the heat-treating of the gel.

42. The method of claim 41, wherein the vacuum-treating comprises vacuum-treating at 0° C. to 110° C.

43. The method of claim 30, wherein the heating comprises heating at 30° C. to 120° C.

44. The method of claim 30, wherein the heat-treating comprises heat-treating at 300° C. to 1500° C. for a time of 0.1 hours to 10 hours.

45. The method of claim 30, wherein the heat-treating comprises a first heat-treating and a second heat-treating, wherein the first heat-treating comprises heat-treating at 30° C. to 600° C., and the second heat-treating comprises heat-treating at 190° C. to 1500° C.

46. The method of claim 43, wherein the heat-treating comprises heat-treating in dry air, nitrogen, helium, argon, or hydrogen.

47. The method of claim 46, wherein
the first heat-treating comprises heating at a ramp rate of 1 to 10° C./min, and the second heat-treating comprises heating at a ramp rate of 0.5 to 5° C./min; and
the second heat-treating further comprises holding for 0.5 hours to 24 hours, preferably 1 to 4 hours at 190° C. to 1500° C., preferably 500° C. to 900° C.

48. The method of claim 30, wherein the method is a solution based synthesis comprising a sol-gel process, a reverse homogeneous precipitation process, or a reverse micelle process.

49. A method of preparing a catalyst, the method comprising:
providing the composition of claim 1 to prepare the catalyst, and
optionally disposing the composition on a support to prepare the catalyst.

50. A method of preparing a gas diffusion electrode, the method comprising:
providing an electrode;
providing the catalyst comprising the composition of claim 1; and
disposing the catalyst on the electrode to prepare the gas diffusion electrode.

51. A method of preparing a metal-air battery, the method comprising:
providing a negative electrode comprising a metal;
providing a positive electrode comprising the gas diffusion electrode of claim 32; and
contacting the negative electrode and the positive electrode with an electrolyte to prepare the metal-air battery.
